(19) United States
(12) Patent Application Publication
(10) Pub. No.: US 2007/0114370 A1
(43) Pub. Date: May 24, 2007

(54) Fiber optic remote reading encoder

(76) Inventors: Ronald H. Smith, Rockville, MD (US); William Robert Allen Ziegler, Ijamsville, MD (US)

Correspondence Address: Mitchell B. Wasson;HOFFMAN, WASSON & GITLER, P.C., Suite 522, 2461 South Clark Street, Arlington, VA, 22202, US

(21) Appl. No.: 11/655,911

(22) Filed: Jan. 22, 2007

Related U.S. Application Data
(63) Continuation-in-part of application No. 10/959,041, filed on Oct. 7, 2004, now Pat. No. 7,166,833.
(60) Provisional application No. 60/509,982, filed on Oct. 10, 2003.

(51) Int. Cl. G01D 5/34

(52) U.S. Cl. 250/231.13

(57) ABSTRACT

A system and method for instantaneously determining the absolute position of a linear or rotary actuator. A code plate having a series of digital words thereon is associated with the linear or rotary actuator. A magnetic or optical code plate is utilized, each code plate provided with N tracks. M signal levels are associated with each point on every track. The use of M-ary signal levels would enable the instantaneous determination of the position of the code plate when power is supplied to the system.

### CROSS-REFERENCED APPLICATIONS

The present application claims the priority of provisional patent application Ser. No. 60/509,982 filed Oct. 10, 2003, and U.S. patent application Ser. No. 10/959,041, filed Oct. 7, 2004, both of which are incorporated by reference.

### BACKGROUND OF THE INVENTION

1. Field of the Invention

The present invention relates to linear or rotary optical encoders used to instantaneously measure the position of a linear or rotary moving element such as an actuator.

2. Description of the Prior Art

It is certainly true that optical encoders are well known in the prior art. A typical optical encoder would be utilized to measure the digital absolute position of a linear or rotary moving element. Generally, these prior art optical encoders would include a code plate having several tracks of alternating dark and transparent bands and an optical emitter and detector on either side of the code plate assigned to reading each band. Alternatively, the emitter and detector may be on the same side of the code plate with the alternating bands having high and low reflectivity. In either situation, an optical emitter/detector combination would be assigned to each of the bands, thereby increasing the complexity and the cost of the system. A typical optical reading encoder capable of resolving the absolute position of the code plate to one part in a thousand would require approximately 10 pairs of optical emitters and detectors to read the 10 tracks on the code plate.

Examples of prior art optical detectors are U.S. Pat. No. 4,602,242 issued to Kimura; U.S. Pat. No. 4,720,699 issued to Smith; U.S. Pat. No. 5,336,884 issued to Khoshnevisan et al.; U.S. Pat. No. 5,451,776 issued to Kolloff et al.; and U.S. Pat. No. 5,748,111 issued to Bates.

The patent to Smith describes an optical encoder employing a line array of detectors. A single strip of encoding bars is used in conjunction with a plurality of detectors 6 to determine the absolute position of the strip of encoding bars. As shown in FIG. 4, a multitude of detector elements 6 must be utilized.

The patent to Kolloff et al. describes an optical encoder for sensing the linear position of an optical medium moving in a linear direction. As illustrated in FIGS. 1 and 2, the encoder includes a rectangular plate 102 provided with a linear absolute track 104 as well as additional linear tracks 110, 112, 114 and 116. Each track is associated with 1 of 5 optical fibers 188, 190, 192, 194 and 196 extending from a distant point with respect to the encoder assembly to connect with other elements. Each of the tracks contains a series of optically detectable marks spaced evenly around the rectangular plate under each of the tracks. Each of the marks is detected by interferometric reflection of coherent light.

The patent to Khoshnevisan et al. is generally related to an optic encoder for sensing an angular position. A circular disc is provided with an angular absolute track 104 as well as a number of additional angular tracks 110, 112, 114 and 116 as illustrated in FIG. 1. Each of the tracks is provided with a plurality of angularly-spaced “dark” or “bright” bits. A plurality of optical fibers 188-196 is used, one optical fiber associated with each of the tracks.

The patent to Kimura describes either a linear or rotary encoder containing a code carrying medium having a fine reading track 21 and a rough reading track 22 which is parallel with respect to one another. The fine reading track 21 is divided into a plurality of blocks 21a and the rough reading track 22 is divided into a plurality of blocks 23.

The patent to Bates describes an apparatus for monitoring the speed and actual position of a rotating member. This apparatus includes a grating portion 114 including a plurality of wedge-shaped pattern markings 22 that are equally spaced around a periphery surface 20. A sensor 16 in conjunction with a processor 18 would determine both the speed and actual position of the rotating member.

None of the above-noted prior art patents describes an optical encoder utilizing a code plate having a plurality of wedge-shaped items defining a plurality of digital words associated with a linear or rotary moving element. Additionally, none of these references would employ a relatively small number of detectors to quickly and efficiently detect the absolute position of the code plate which, in turn, is associated with the actual position of the linear or rotary moving element.

Furthermore, none of the above-noted prior art patents describes an encoder for the instantaneous determination of the position of an element, such as an actuator, at the particular moment that is provided to the encoder. This is important particularly when power is initially lost to the encoder and/or the actuator and then power is restored to the encoder and/or actuator, especially when the encoder is used in a hostile environment.

### SUMMARY OF THE INVENTION

The deficiencies of the prior art are addressed by the present invention which describes an optical absolute position encoder including a code plate having a plurality of encoder elements forming, in turn, a plurality of digital words extending for at least a portion of the entire length of a linear position encoder or provided along the periphery of at least a portion of a rotary position encoder. Although the present invention can be applied to both a linear encoder as well as a rotary encoder, for ease of explanation, we will limit our discussion to a linear encoder. One or two optical emitter/detector combinations would be utilized to read the digital absolute position of the code plate. Each of the emitter/detector combinations would be provided on a single sensor head. When two pairs of emitter/detectors are employed, each would be provided on a separate read head separated from one another by a precise distance.

Each of the digital words would contain a Most Significant Bit (MSB) and a plurality of additional bits, thereby creating a multi-bit digital word. The code plate would contain a plurality of these digital words. Each of the digital bits of each of the words would represent either a digital “0” or digital “1” based upon whether the reflectivity of each of the encoder elements was decreasing or increasing in the direction of movement assigned a positive value on the code plate. Each of the bits would constitute a plurality of parallel encoder tracks. Within each bit of the digital word, based upon the exact reflectivity sensed by each optical detector or detectors, the analog, or exact position of the code plate would then be determined.

The present invention would employ a Gray code relationship whereby each digital word would only differ by the change of one bit from each adjacent digital word.

A signal processing device is used to operate the optical decoder according to the present invention. This signal processor would be provided with sufficient software and memory for properly controlling the operation of the present invention. The memory of the signal processor would be provided with the position of each of the digital words on the code plate as well as the orientation, which defines bit value of each of the encoder elements on the code plate. Therefore, utilizing the information gathered by the optical detector or detectors, the exact position of the code plate and its associated moving element would be determined. Once the signal processing device determines the exact position of the moving elements, it would be relayed to an appropriate output device.

The present invention is designed to operate in various electromagnetic and volatile environments. Therefore, to combat electrical magnetic interference, as well as to ensure that no sparks are generated, each of the optical detector/emitter combinations would be in communication with an optical waveguide, thereby allowing for a remote reading of the position of the code plate and its associated actuator.

Another embodiment of the present invention is directed to an encoder, also used in conjunction with a code plate to determine the absolute position of an actuator, or other device, associated with the code plate. In this context, as was true with the previous embodiment, the code plate would move in concert with either a linear or rotary moving element.

The purpose of this new embodiment is to determine the exact position of the code plate, and hence the actuator, at the time that power is either initially applied to a system utilizing the encoder and the code plate, or when power is applied as a recovery from a power outage. The code plate would be provided with a plurality of tracks, with each track allowing a sensor to sense one of two or more signal levels. Computer software or hardware associated with the operation of the actuator would be able to locate the exact position of the code plate and, therefore, the actuator, based upon the recognition of the exact digital word containing the same number of bits as the number of tracks on the code plate corresponding to the location of a plurality of sensors or read heads, one for each of the tracks. Similar to the previously described embodiment, a Gray code relationship is provided in each of the digital words in which each digital word differs from an adjacent digital word by the change of only one bit. For example, if three signal levels are used, the value change is always one increment; never 0 to 2 or 2 to 0. Possible value changes would be 0 to 1, 1 to 0, 1 to 2 or 2 to 1. As a result, the magnitude of the value change is known in advance.

Various types of encoders can be utilized by the second embodiment of the present invention. For example, a carbon nanotube sensor, sensitive to different magnetic fields, each magnetic field strength corresponding to a signal level may be employed. Furthermore, an optical sensor could be utilized, with the optical sensor, sensitive to various discrete reflection values provided on the code plate, each reflection value indicative of a particular signal level.

### DESCRIPTION OF THE DRAWINGS

The present invention will be better understood when consideration is given to the following detailed description thereof. This description makes reference to the following drawings wherein:

FIG. 1 is a block diagram of the present invention;

FIG. 2 is a diagram showing a typical digital word;

FIG. 3 is a readout of the digital word in FIG. 2;

FIG. 4 is a diagram of the digital word of FIG. 2 including a top view of two optical sensor heads;

FIG. 5 is a side view of the present invention in which the sight line is orthogonal to the measurement direction;

FIG. 6 is a block diagram of a method of determining position according to the present invention;

FIG. 7 is a block diagram providing a method of determining position when fully operational position readout is established;

FIG. 8 is a trace of encoded detected signals according to the present invention;

FIG. 9 is a side view of the present invention in which the sight line is parallel to the measurement direction;

FIG. 10 is a diagram showing a plurality of four bit digital words utilized by a second embodiment of the present invention;

FIG. 11 is a diagram showing a magnetic code plate and sensor configuration utilized by the second embodiment of the present invention;

FIG. 12 is a diagram showing the optical code plate and sensor configuration utilized by the second embodiment of the present invention;

FIG. 13 is a graph illustrating a situation showing improper wavelength separation between light sources utilized by the second embodiment of the present invention;

FIG. 14 is a graph showing the absorption of three magnetic fields for a single wavelength utilized by the second embodiment of the present invention;

FIG. 15 is a graph showing potential outputs of the magnetic code plate of FIG. 11 utilized by the second embodiment of the present invention;

FIG. 16 is a graph showing potential outputs of an optical sensor utilized by the second embodiment of the present invention; and

FIG. 17 is a graph showing the output of the magnetic sensor of FIG. 11 having one defective track.

### DETAILED DESCRIPTION OF THE PRESENT INVENTION

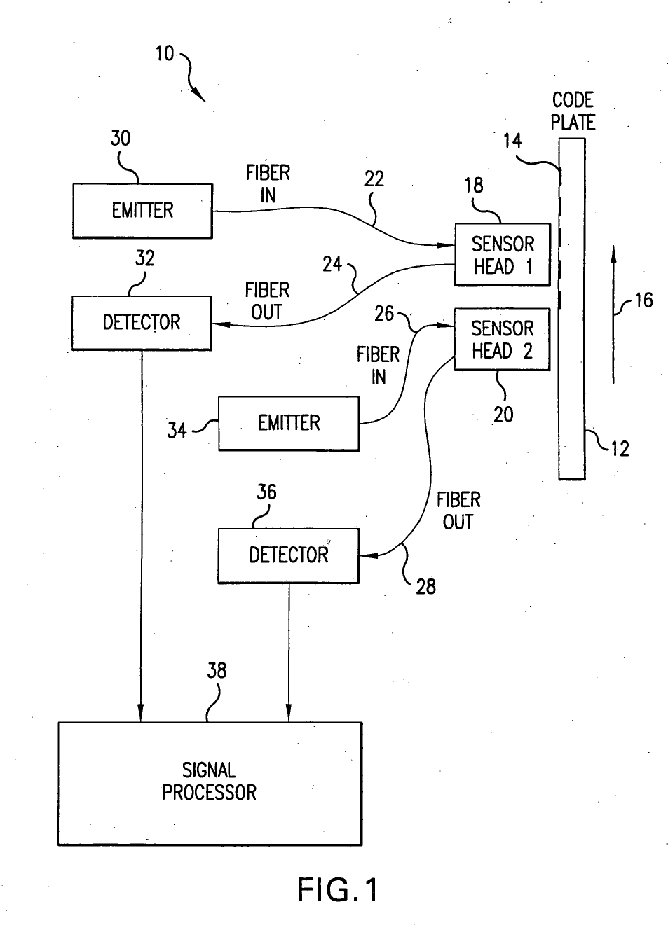

A block diagram showing the basic elements of the present invention 10 is illustrated with respect to FIG. 1. An encoder code plate 12 is associated with the movement of an element, such as either a linear actuator or a rotary actuator (not shown). The code plate 12 is either directly applied to the surface of an actuator or is attached to an actuator in a manner such that movement of the actuator is correlated with movement of the code plate 12, thereby providing an exact determination of the position of the actuator. The code plate 12 is generally transparent and would be provided on its surface with a plurality of digital words, each digital word consisting of a plurality of digital bits. Each of the digital bits would contain a plurality of parallel reflecting like-shaped encoder elements each having the same bit pitch. Therefore, each of the encoder elements of each of the digital bits would vary the reflectivity of an optical signal projected onto the code plate, over the length of that particular digital bit. The encoder elements 14 are broadly shown in FIG. 1. Reference will be made to additional figures to illustrate the exact structure of the encoder elements of each of the bits which in turn would create a digital word. As depicted in the additional figures, the encoder elements 14 take the form of wedge-shaped elements.

The wedge-shaped elements produce an approximately linear variation of detected signal amplitude across the span of a single digital bit. It will be obvious to those skilled in the art that other means, such as micro scale variation of coating density or approximately linear changes in the reflection spectrum may alternatively be used to produce a discernable variation in the detected signal across a bit.

Although the present invention could operate utilizing a multitude of sensor heads, as has been described hereinabove, the present invention would generally utilize one or two sensor heads. The use of only one sensor head would result in a savings of money in producing the optical reader according to the present invention but would sacrifice the ability to maintain a continuous linear reading. In addition, the use of only a single sensor head would reduce the complexity of a processor utilized with the present invention and would also increase the speed of the processing of the present invention. However, as indicated hereinabove, this is done by sacrificing the ability to maintain a continuous linear reading. Therefore, for ease of discussion of the present invention, we will limit our description to an encoder utilizing two sensor heads.

As shown in FIG. 1, a first sensor head 18 will be provided at a relatively close distance above the code plate 12. A second sensor head 20 would also be provided at a relatively close distance from the code plate 12. The sensor head distance is minimized by making the reflective surface of the code plate 12 face the sensor head. The sensor head is placed as close as possible to the code plate 12 consistent with avoiding physical contact that might cause wear on the code plate reflectivity material in the presence of shock and vibration. An input fiber optical waveguide 22 would be connected between the sensor head 18 and an emitter 30 for emitting the proper optical radiation, such as a laser beam. An output fiber optical waveguide 24 would be connected between the sensor head 18 and a detector 32 for sensing the reflected optical power of the laser output reflected off of the wedge-shaped digital bits. As previously discussed, the reflectivity of each digital bit would change over the length of that digital bit, thereby allowing the present invention to determine the exact position of the sensor head with respect to the code plate 12.

The second sensor head 20 is provided at a close distance from the sensor head 18 and, similar to the sensor head 18, would be provided with an input fiber optic waveguide 26 connected between the sensor head 20 and an emitter 34 providing an optical output to the sensor head 20, such as a laser output. An optical fiber optical waveguide 28 is provided between the sensor head 20 and a detector 36. Both detectors 32 and 36 are connected to a signal processor 38 for determining the exact position of the code plate 12 based upon the outputs transmitted by the detectors 32 and 36 to the signal processor 38. Similar to the optical output signal generated by the first sensor 18, the output of the second sensor 20 is also indicative of the reflected optical power of the optical signal reflected off of one of the encoder elements 14. Generally, both of the sensor heads 18, 20 remain stationary while the code plate 12 moves above or under the sensor heads. However, for convenience in describing the encoder operation, we adopt the convention of having the sensor head in motion relative to a fixed code plate.

The two waveguide sensing heads 18, 20 are separated in the measurement direction as depicted by arrow 16 by, for example, 0.5, 1.5, 2.5 or 3.5 times the bit pitch of the individual encoder elements 14. This separation assures that handing the signal readout back and forth from one fiber pair to another fiber pair will maintain a linearly-varying signal versus position of relationship over the entire encoder range. Maintaining a constantly linear signal in turn would allow the encoder to provide the absolute position at all times without correlation with other sensor data. The loss of signal as a function of sensing head distance from the code plate reflecting surface is proportional to the distance between the code plate 12 and each of each of the sensor heads 18, 20. The sensing head distance is minimized by making the reflective surface of the code plate 12 face the sensing head. Therefore, although the present invention could operate with the input waveguide provided on the opposite side of the code plate 12 with respect to the output waveguide, the present invention will be described with respect to a sensing head having an input waveguide and an output waveguide on the same side of the code plate.

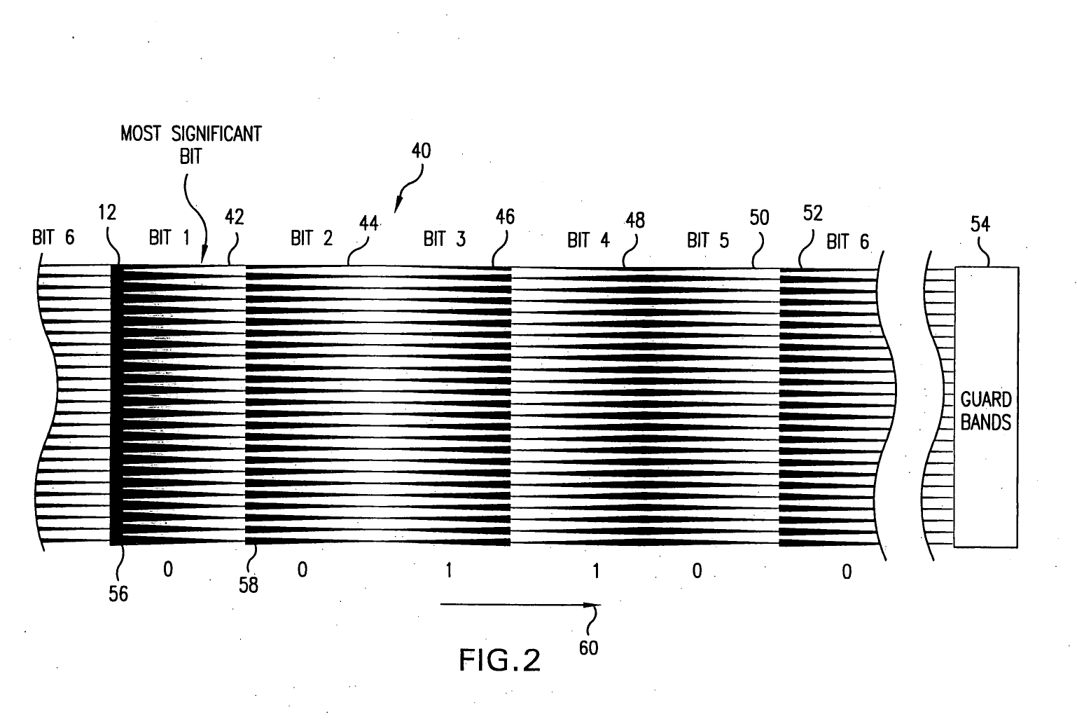

A typical digital word 40 is illustrated with respect to FIG. 2. This digital word 40 consists of a plurality of digital bits 42, 44, 46, 48, 50 and 52. Although the exact number of digital bits comprising each digital word is not crucial for the teaching of the present invention, for purposes of illustration, we will utilize a digital word containing six bits. Since each digital bit represents either a digital “0” or a digital “1”, the number of distinct digital words that can be provided on a code plate would be 2⁶ which equals 64 digital words. Therefore, a code plate consisting of digital words, each digital word comprised of six digital bits, would allow a total of 64 different digital words to be provided on the code plate.

Each digital bit contains a plurality of equally-shaped reflecting wedges whose thickness varies in a linear manner from one side of the digital bit until the second side of the digital bit. For example, the leftmost side 56 of bit 42 is relatively thick and the thickness of each of the wedges of bit 42 would decrease in size linearly until it reaches edge 58. The distance between edges 56 and edges 58 is the same for all bits and is called the bit pitch. The reflectivity of bit 42 is highest at the thickest part 56 of the bit 42 and is lowest at the thinnest part 58 of the bit 42. Therefore, the encoder reflectivity would vary as the code plate moves above or below the stationary sensor heads 18, 20. A rising slope would be equated as a digital 1in which the thickness of the wedge increases in the measurement direction 60, as, for example, bit 46. A falling slope such as shown in bit 42 would denote a digital 0. Consequently, since the signal processor 38 is aware of the exact position of each of the digital words provided on the code plate 12, once it is established where the sensing heads are positioned within a single digital word or, in the instance of two sensing heads, in one digital word or an adjacent digital word, the absolute position of the code plate can be determined to a resolution of one bit pitch. This bit pitch resolution determination is then refined in an analog manner by determining the exact position of the sensor head or heads within a particular bit of a particular digital word by the determination of the reflectivity of the wedge-shaped element of that particular digital bit, since the variation of reflectivity across the bit pitch of each of the wedges is known. Therefore, once it is determined over which digital word the stationary sensor head is positioned, it can then be determined, utilizing the exact reflectivity level, the exact position within that digital bit of the particular digital word. The digital words can be placed on the code plate 12 to utilize a binary Gray code wherein each digital word differs from its adjacent digital word by only a single bit. Since the present invention employs a six-bit digital word, a six-bit binary Gray code would be employed. The single bit change from word to word in a Gray code provides an indication of error-free operation.

Furthermore, a plurality of guard bands 54 is provided at both ends of a linear code plate. It is possible that a rotary code plate would employ only a single grouping of guard bands. Assuming that the digital word 40 shown in FIG. 2 is the last word at the high end of the code plate, guard bands 54 would include a series of high-reflection “1” bits. This is contrasted to the series of guard bands which would be provided at the low end of the code plate, these guard bands providing a series of low reflection “0” bits. The use of these guard bands 54, along with the fact that the signal processor 38 is aware of the exact position of each of the digital words, would prevent the code plate 12 and its associated actuator from moving beyond a particular point in the measurement direction. The guard band 54 provides the preferred travel direction indication within one bit pitch distance of the motion of the code plate 12.

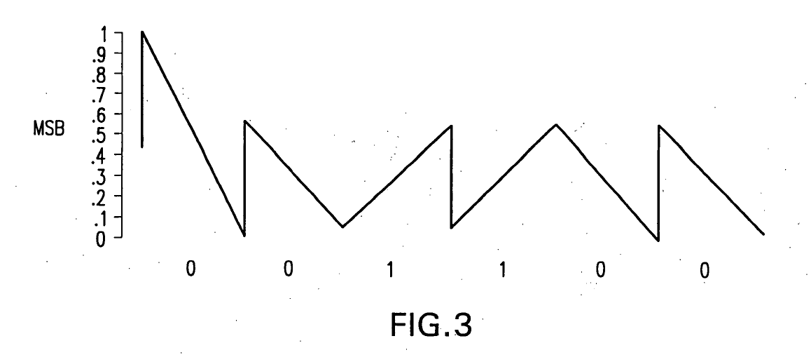

As shown in FIG. 2, digital word 40 has the digital notation of 001100. Since it is important to determine the exact digital word sensed by the sensor heads 18, 20, the leftmost bit of each of the digital words is designated as the most significant bit (MSB) of each word and this bit can be differentiated from the other five bits of a six-bit digital word. In the case of FIG. 2, the most significant bit is denoted as bit 42. Therefore, as one of the sensor heads 18, 20 moves over digital word 40, the sawtooth waveform as illustrated in FIG. 3 would be produced. It is important to note that the dynamic range of the most significant bit 42 is twice that of the dynamic range of all of the other bits of digital word 40. Bit 1 of every digital word included on the code track 12 is a most significant bit differentiated from other bits by the double size dynamic range. It is the use of this greater dynamic range that would allow the present invention to determine the position of the most significant bit of each of the digital words.

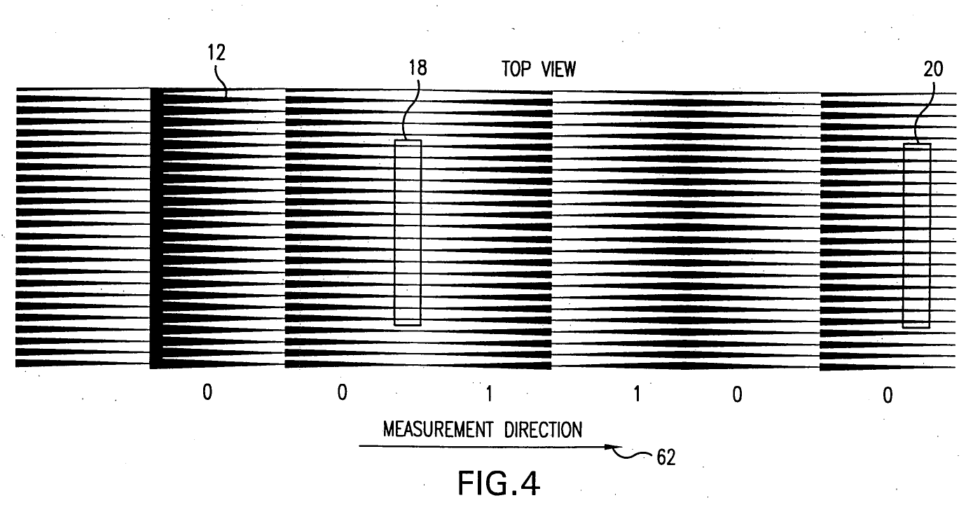

FIGS. 4, 5 and 9 show a top view and two side views of the present invention, respectively. Although the code plate may move while keeping the sensor heads 18, 20 stationary, we adopt, as previously noted, a convenient understanding that even in such a case, the sensor head and code plate experience relative motion and describe this as the sensor heads moving. Likewise, the sensor head may move in either of two opposite directions. As the sensor heads 18, 20 move in the measurement direction 16, chosen arbitrarily, the read heads pass over various digital bits of various digital words of the code plate 20. Measurement direction 16 corresponds to increasing in a Cartesian coordinate system. As previously indicated, the sensing head distance between each of the heads and the code plate 12 is placed as close as possible consistent with avoiding physical contact that might cause wear on the code plate reflecting material in the presence of shock and vibration. Typical distances between the sensor heads and the code plate would be between 20 and 100 microns. It is noted in FIG. 4 that length of each of the sensor heads 18, 20 is less than the width of the code plate 12 to allow for jitter.

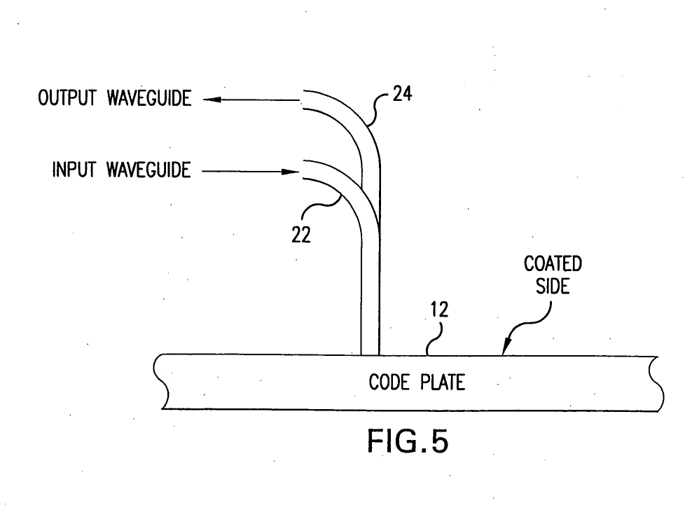

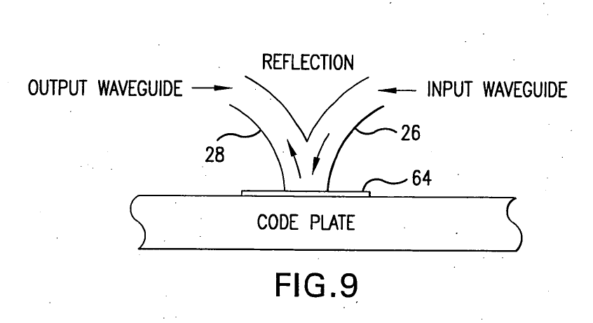

Minimal optical power loss is achieved by use of a planar waveguide coupler having two branches 26, 28 converging on an exit face 64. Emitted light passes through one branch, out of the coupler and is reflected off of the code plate and passes back into the other coupler branch. The planar waveguide coupler would have an in-plane dimension, seen in FIG. 9, substantially greater than the out-of-plane dimension, seen in FIG. 5. The out-of-plane dimension would be aligned in the measurement direction of the optical encoders. This would create a situation where very little light is lost due to beams spreading in the in-plane direction. The multi-mode fiber utilized as the waveguides would accept multi-mode fiber input and output with minimal insertion loss. While high resolution is one of the objects of the present invention, an extreme high resolution is achievable utilizing only a single mode optical fiber. However, the resolution utilizing a multi-mode fiber is sufficiently high to provide the results required by the present invention.

The particular signal processor 38 used in the present invention would be chosen based upon the type of response time contemplated. Short read-out response time depends on the signal processor speed and the particular processor algorithm employed. In order to accommodate a rapid response time, the algorithm can output an immediate position value based solely on signal amplitude variation handed off from the two sensing heads, followed by confirmation of the absolute position based on the next decoded digital word. This method allows the shortest instantaneous response to motion combined with reasonably rapid confirmation of the absolute position.

High resolution of the present invention is obtained by using all of the possible digital words based upon the number of digital bits in each digital word. For example, in the embodiment illustrated in FIGS. 2 and 4, in which each digital word contains six bits, a possible 64 different digital words can then be created. Since each digital word contains six bits, this results in a total 384 bits. If the position within a given bit can be resolved to 1/10 of a bit based upon the signal amplitude within a linear variation range, then the position of the sensor head can be determined absolutely to one part in 3,840. A practical limit on the resolution may be 1/100 of a bit having a 30 micrometer pitch. This produces position resolution of one part in 3,300,000 over a one meter code plate. Obviously, the length of the code plate can be extended arbitrarily by increasing the number of bits in the encoder word.

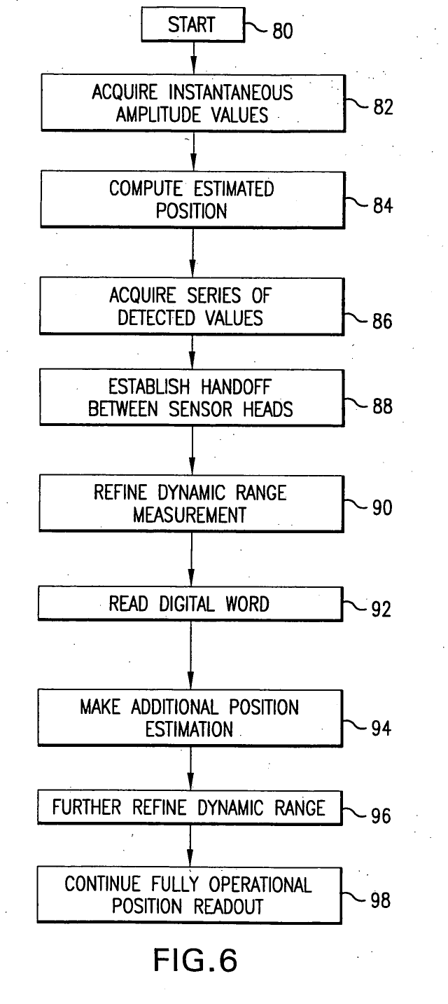

Your attention is now directed to FIG. 6 which illustrates a simplified flow diagram explaining the manner in which the present invention determines the initial position of the code plate based upon the position of one of the sensor heads. It should be noted that the following algorithm as illustrated with respect to FIG. 6 is but one of a number of algorithms which could be used to determine the exact position of the code plate.

When the system is turned on, either initially or after a loss of power, the positioning algorithm will be initiated at step 80. At this point, both of the sensor heads 18, 20 would obtain an amplitude value of the particular spot of the bit of a particular digital word over (or under) the sensor is positioned at step 82. The value of the instantaneous amplitudes would form a first estimate of the position of the designated sensor head 18 or 20. These instantaneous amplitude values are designated as d[1,1] and d[2,1]. At this point, step 84, an estimated position of the sensor head and, of course, the code plate would be determined utilizing the following equation:
X₀=(2L/D)[(d[1,1]+d[[2,1])/2−D/4−D₀] 1
where

L=Full measurement range

D₀=Lowest signal level

Dₘₐₓ=Highest signal level

D=Dₘₐₓ−D₀=Full system dynamic range

The ability to make this estimation depends on code plate less significant bits using less than the full dynamic range and shifting from an average of D/4 to an average of 3D/4 across the full code plate length.

A series of detected values is then acquired at step 86. These detected values represent a dynamic range used by all of the bits with exception of the most significant bit. A second estimation of position is then made. These detected values are acquired after several cycles of rising and falling signal levels as sensed by both of the detectors. During the initial determination of the position of the code plate, the code plate might be forced to move at least in one direction allowing the sensor heads to acquire these additional values. The maxima and minima of these values d[1,j] and d[2,j] are observed, out of phase. All of the signal values detected would be recorded using sequence indicator j for later processing reference. The values 1 or 2 for d[i,j] define which of the sensor heads is providing a given detected signal; i=1 for sensor head 18 and i=2 for sensor head 20. A sample rate is established using the number of samples per cycle as a measure and, for example, ten samples per cycle as a criterion. The average of cycle peaks (highest value in a given cycle, D_{MAX}) and average of cycle valleys (lowest value in a given cycle, D_{MIN}) are then measured. The most significant bit (MSB) is identified using:
d_{MAX}[i,j]−d_{MIN}[i,j]>1.5*((average of d_{MAX})−(average of d_{MIN})) 2

Excluding the MSB, the average of cycle peaks and the average of cycle valleys are noted. The dynamic range d₁ of all of the bits other than the MSB is as follows:
d₁=(average of d_{MAX})−(average of d_{MIN}) 3

The detected signal mid value dₘ is determined utilizing:
dₘ=((average of d_{MAX}))+(average of d_{MIN}))/2 4

Based upon these computations, an estimated position X₁ is computed with step 86:
X₁=(L/d₁)[dₘ−D₀−d₁/2] 5

Equation 5 captures the early position estimation benefit associated with a gradual rise in the dₘ value across the code plate.

Once this second estimated position is determined, a hand-off back and forth is established between detected signals d[1,j] and d[2,j] from sensor heads 18 and 20 at step 88. As an initial sub-step within step 88, Table T is formed. Each time the detected signal values d[1,j], d[2,j] are acquired, j would be incremented by 1 and new detected signal values would be added. Let P be the distance along the X axis equivalent to 1 bit pitch, and assume that the sensor heads are separated by 3.5 P. Table T is scanned for the first instance of d[1,j] in a range which can occur only if the detector d[1,j] is reading an MSB (d[1,j] above d_{MAX} [i,j]+0.12d₁ or below d_{MIN}[i,j]−0.12d₁)

TABLE T

| j | d[1, j] | d[2, j] |
|---|---|---|
| 1 | d[1, 1] | d[2, 1] |
| 2 | d[1, 2] | d[2, 2] |
| 3 | d[1, 3] | d[2, 3] |
| . . . | . . . | . . . |

If d[2,j] encounters an MSB first, the roles of d[1,j] and d[2,j] can be reversed relative to this description, resulting in a small reduction in time to acquire the next stage of absolute position improvement.

j₁ is designated the first j for which d[1,j] can only be an MSB. Assume initially that increasing j is initially capturing data from increasing X positions. This assumption will be either validated or reversed and corrections applied later in the process. Determine sign of MSB (=MSBS) at j₁ as MSBS=+1 if d[1,j] vs j slope is positive and MSBS=−1 if d[1,j] vs j slope is negative.
D_{Mid}=(D₀+Dₘₐₓ)/2 6
D=Dₘₐₓ−D₀ 7

Form fourth and fifth columns of table [T] for ΔX₁ and ΔX₂. For all rows before and after j₁ in which d[1,j] stays between d_{MIN}+0.13*d₁ and d_{MAX}−0.13 d₁ assign a value of ΔX₁.
ΔX₁=(MSBS)*P*(d[1,j]−D_{Mid})/D 8

For those j near j₁ in which the absolute value of ΔX₁ is between 0.32*P and 0.43*P, determine whether d[2,j] is tracking d[1,j] with the same or opposite sign of slope relative to ΔX₁ ordinate. Based on this determination, assign a value of +1 or −1 to the bit slope of a bit in which d[2,j] is positioned (BS=1 or −1). Also establish the sign of + or − direction of motion (DS=1 if motion is increasing X through d[1,j], d[2,j] transition and DS=−1 if motion through transition is decreasing X. Establish cumulative position (CP) index which is incremented by P/2 when DS=1 and reduced by P/2 when DS=−1. Enter in column 5 values for ΔX₂ when d[2,j] is between d_{MIN}[1,j]+0.13*d₁ and d_{MAX}[1,j]−0.13*d₁:
ΔX₂=CP+BS*P*(d[2,j]−d_{M})/d1 9

The ΔX₂ value from Equation 9 refers to the position of sensor head d[1,j] inferred from sensor head d[2,j] data. Sensor head d[1,j] is therefore a universal reference position element regardless of whether data defining position enters via sensor head d[1,j] or d[2,j].

Transitions from d[2,j] to d[1,j] are made in a similar manner to those from d[1,j] to d[2,j] and the formula for ΔX₁ when d[1,j] is the differential position data source is:
ΔX₁=CP+BS*P*(d[1,j]−d_{M})/d₁ 10
with CP and BS determined as was done for ΔX₂. In general, bit transitions will continue to occur as the code plate moves. Back and forth motion is accommodated by reversing CP accumulation trend when a bit transition is preceded by a direction reversal and maintaining the CP trend when bit transitions occur without direction reversal.

The dynamic range measurement is refined at step 90. As ΔX changes, determine values of d_{MAXO} [i,j], dₘᵢₙₒ[i,j] and D for which the following expressions are minimized:

$$\begin{matrix}\sum {( \frac{Δ xD}{2 L} + {d}_{MINO} - d [ i , j ] )}^{2} & 11 \\ \sum {( \frac{Δ xD}{2 L} + {d}_{MAXO} - d [ i , j ] )}^{2} & 12\end{matrix}$$

where d_{MINO} is the minimum d[i,j] associated with low-to-high or high-to-low LSB transition, d_{MAXO} is the maximum d[i,j] associated with a low-to-high or high-to-low LSB transition in the sampled data and only ΔX and d[i,j] values associated with minima or maxima of the d[i,j] series are considered.

Continuously gather data and improve dₘᵢₙ[i,j] and dₘₐₓ[i,j] and D estimation accuracy. Formulas 1 through 12 require small corrections such as:
d₁=fl*(d_{MAX}[i,j]−dₘᵢₙ[i,j] 13

These correction factors, along with estimated numerical values for signal thresholds given above, will be determined during system calibration.

Based upon this information, the first digital word is read at step 92.

As the code plate moves, the absolute value of ΔX will reach 2.5*P, then 3.5*P. If d[2,j] reaches the center of an MSB at ΔX=3.5*P, the direction of net motion is increasing X. d[2,j] at X tracking exactly d[1,j] previously obtained when sensor head 1 was positioned at X will verify this determination. If d[2,j] reaches an MSB center at ΔX=2.5*P, direction of motion is decreasing X and that determination is verified by d[1,j] at X tracking exactly d[2,j] previously obtained when sensor head 2 was positioned at X. If the direction of motion is decreasing X, assign a negative sign to X motion and reassess tabulated ΔX values.

For increasing X, assign bit value=1 for rising slope and bit value=0 for falling slope. If the encoder passes new bits while moving in the −X direction, the bit value assignment criteria must reverse signal slope referenced to j sequence numbers in order to maintain a consistent bit value assignment referenced to the X axis.

Associate bit values with integer multiples of bit pitch in the direction of increasing X. For example, MSB is bit 0, bit with X=P at center is bit 1, bit with X=2P at center is bit 2, and so on up to bit 5. Use d[1,j] as reference for bit number determination.

When bits 0 through 5 associated with any MSB have been assigned values, decode digital word, using the Gray code as a reference.

A third position estimate is made at step 94.

Assign X value to center of MSB for decoded word:

X=(Decoded number)*P*6

Continue to gather bit identification as X value changes, following methods outlined above. Assign X values to MSB center of each new word decoded.

When the first word is decoded, the position of the decoded word in a system memory database is determined.

The dynamic range is further defined as step 96 and the differences between the model predictions and d(i,j) measurements are assessed. D, D₀, D_{MAX}, d_{MAX} and d_{MIN} values are corrected by an amount corresponding to the systematic drift that is measured. All system parameters are constantly updated to adapt to drift in the optical input signal strength or system throughput variability. If dramatic corrections occur, a possible malfunction is noted.

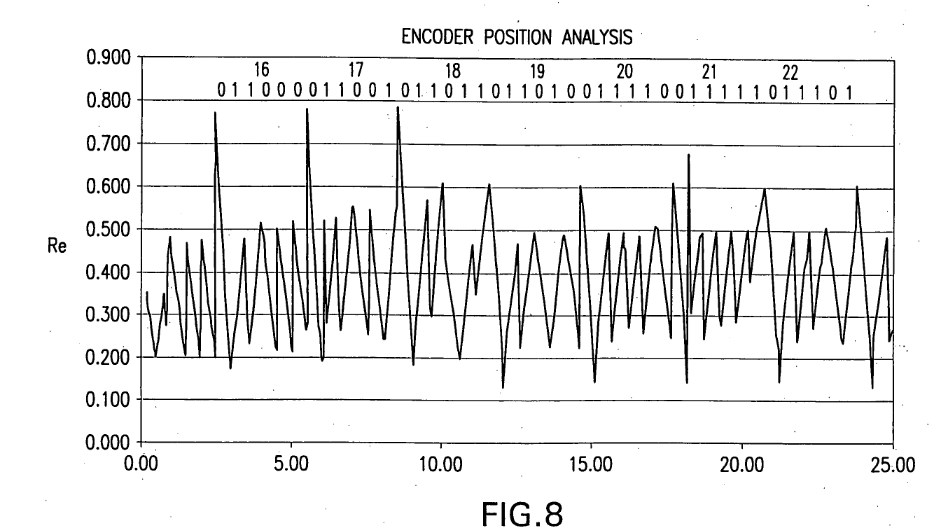

FIG. 8 illustrates a trace of the detected optical signals d[1,j] where the sensor heads are moving at a constant speed in a single direction. This trace could be decoded to output X values employing the previously described algorithm.

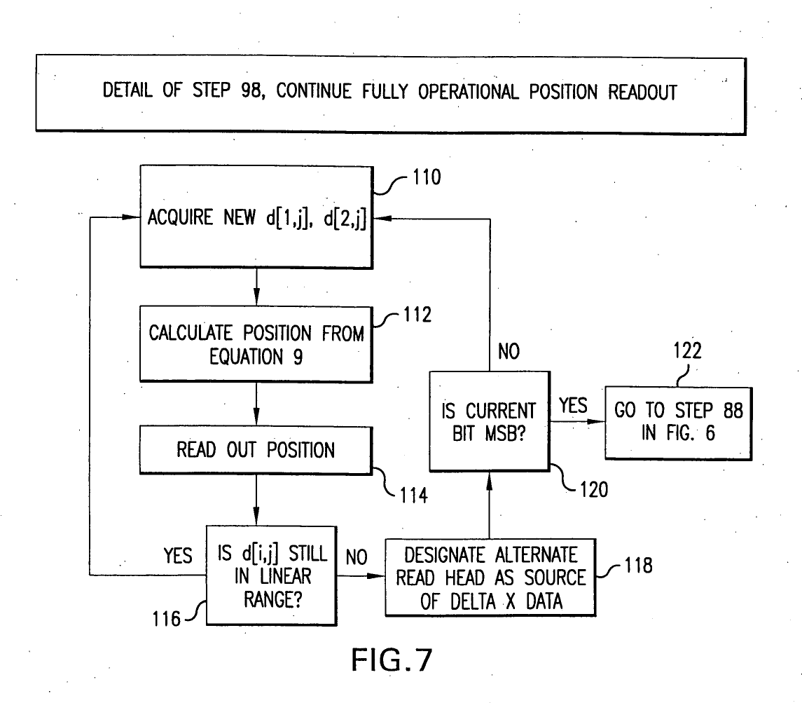

Once the exact position of the code plate with respect to one of the designated sensors is determined, movement of the code plate from this first detected position to all subsequent positions are easily made based upon movement between a first digital bit and one or the other of the two digital bits adjacent to this first digital bit. The exact position of the code plate is then determined based upon the reflectivity value sensed by the sensor heads which, in turn, is a function of the exact position of the sensor head with respect to a bit within the digital word. Utilizing the binary Gray code would act as a further check on the position of the code plate since each of the adjacent digital words should differ from one another by only a single bit. A block diagram illustrating continuing operation of the encoder after a first digital word has been obtained is shown in FIG. 7. The block diagram of FIG. 7 provides a higher level of detail with respect to step 98 of FIG. 6.

As shown in FIG. 7, once the initial position of the code plate is determined, when the code plate moves, a new d[1,j], d[2,j] would be determined at step 110. A new position of the code plate is then determined from Equation 9 or 10 at step 112, at which point the position of the code plate is again read out at step 114. If d[i,j] is still in a linear range, the algorithm would proceed again to step 110. If it is not in the linear range, at step 116, the alternate sensor head would be designated as the source of ΔX at step 118. A determination is then made whether this new digital bit is the MSB at step 120. If it is not, the algorithm would then repeat at step 110. If this new bit is a MSB, you would return to step 96 in FIG. 6, in which the dynamic range is refined.

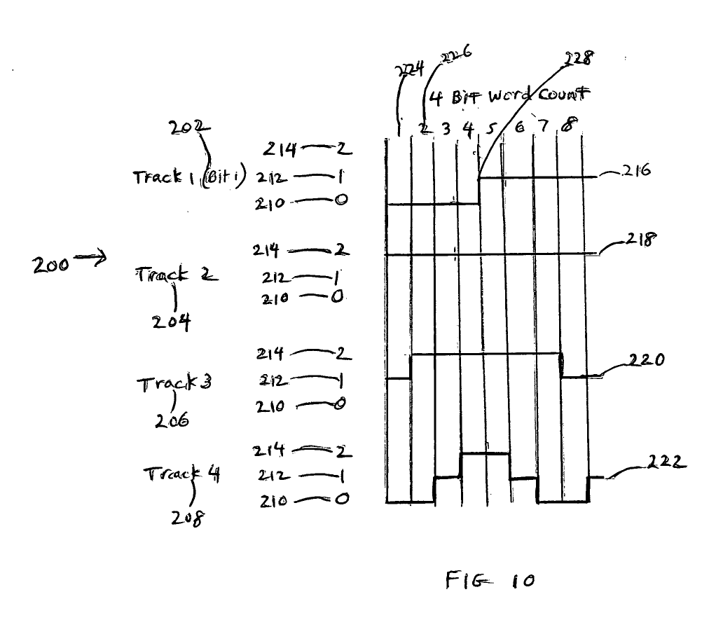

FIG. 6, as previously described, illustrates a method of determining the position of the code plate, either when power is initially applied to the system, or after a loss of power. However, this method can never instantaneously determine with a level of accuracy, the exact position of the code plate 12 and, in turn, the actuator to which it is affixed. The second embodiment described in this application can instantaneously determine the exact position of the code plate. As illustrated in FIG. 10, a system would be utilized to instantaneously determine the position of the code plate. Although FIG. 10 embodies base three number values, which correspond to three distinct signal values, the present invention contemplates the use of an M-ary system, when M≧2. On recovery from a power outage, or initially powering the system, the absolute position of the code plate can be instantaneously determined from the signal levels creating an N bit digital word. Since the code plate is either directly applied to an element or actuator, or is connected to the element or actuator, the exact position of the element or actuator can be determined.

For purposes of illustration, FIG. 10 shows the use of a base three system using three signal levels, however, any number of signal levels can be utilized, with the proviso that a Gray code relationship be provided between each bit of a particular digital word. For example, FIG. 10 illustrates a system utilizing an N bit word wherein N=4, which equals the number of tracks on the code plate. Each bit of any digital word would be included in respective tracks 202, 204, 206 and 208 of a code plate 200. Utilizing three distinct, but equal, signal levels 210, 212 and 214 of each track, a sensor or read head associated with each of the tracks would be able to determine the correct signal at a particular point on that track, such as shown at 224, 226. Consequently, each track would be provided with at least one signal level for the entire length of that particular track, such as shown at 216, 218, 220 and 222. Therefore, the tracks returning discrete levels define at least one predetermined signal level, which constitutes an immediately normalization reference for all levels. A further advantage of the present invention is that as soon as motion equal to an encoder resolution of approximately 0.001 inch, for example, would occur, the direction of motion of the code plate would also be known.

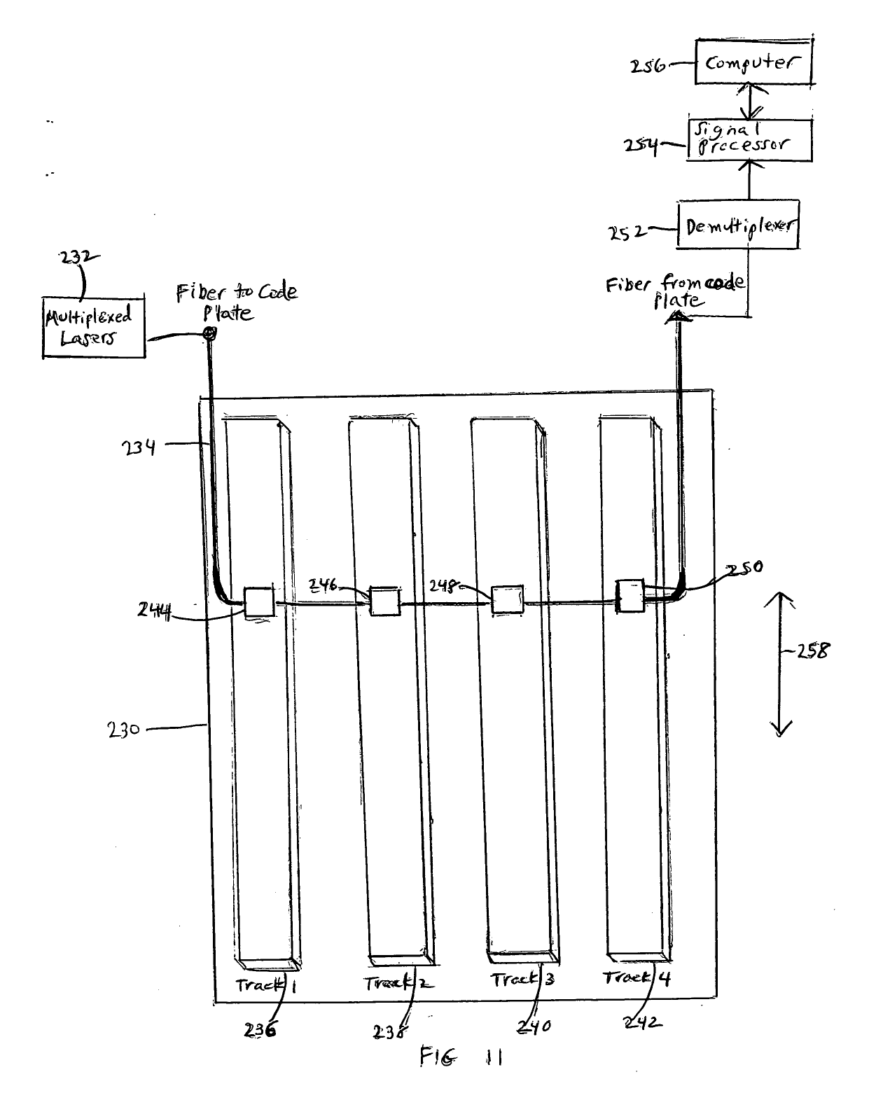

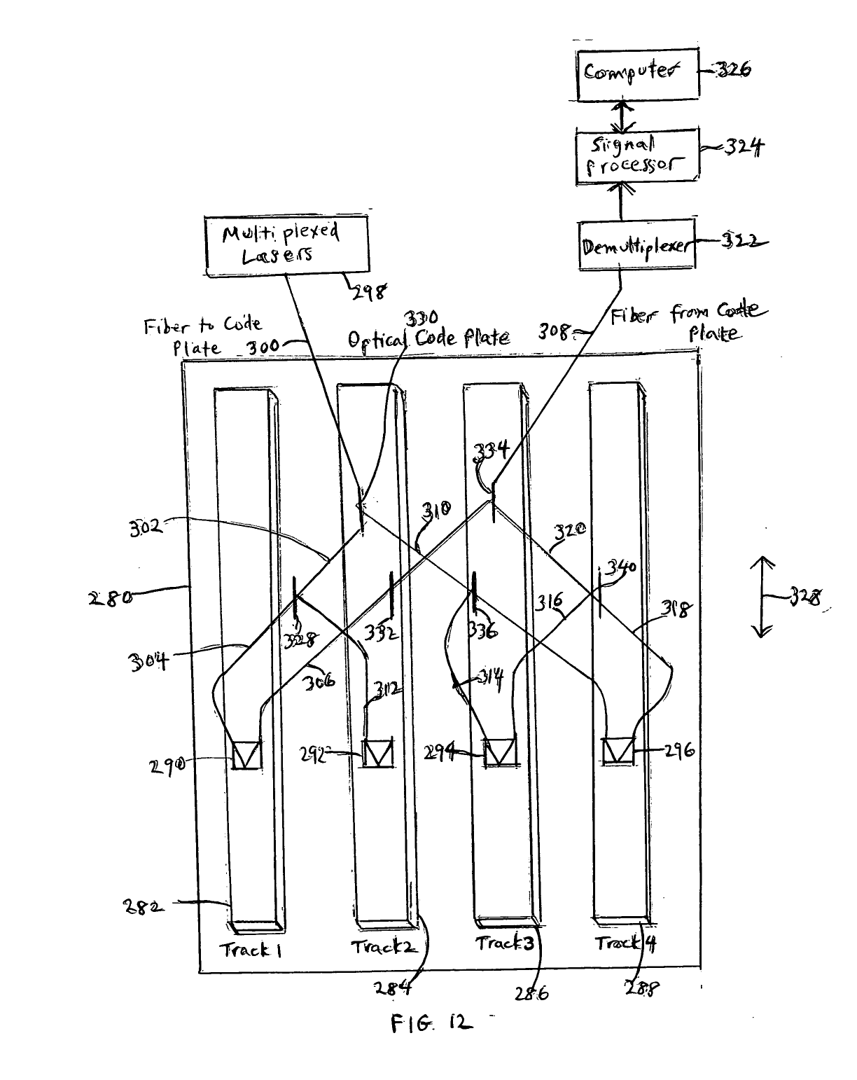

As can be appreciated, one of the sensor heads, such as the one associated with track 1, would be directly over a transition point between a zero signal and a one signal. This occurs at 228 in the short code plate segment, illustrated in FIG. 10. It is noted that since all of the sensors are aligned with one another, as is shown in FIGS. 11 and 12, and a Gray code system is utilized, only one sensor head can ever be aligned over such a transition point. Therefore, movement of the code plate in either direction for one half bit length would place all sensing heads in a location with no ambiguity of the bit value. Furthermore, the signal level associated with a bit in transition will be intermediate between two discrete levels defining two adjacent bit values. Either of these two bit values, in combination with the remaining unambiguous bit values, defines a location on one side or the other of the transition. Therefore, the encoded position at a transition need not be ambiguous. With appropriate signal processing, the code plate position is pinpointed at a uniquely defined transition between two fully defined locations. In fact, the analog variation of the transiting bit provides a means of extrapolating the code plate position to a fraction of a bit spacing during the transition event, a resolution enhancement.

Various types of sensors can be utilized to determine the position of a sensor head along a specific track of the code plate. FIG. 11 illustrates the use of a magnetic code plate 230. Although it is possible that a sensor or sensor array can move with respect to an immobile code plate, for the purpose of explaining the operation of the present invention, the sensor array does not move and the code plate is capable of moving in two directions, as shown by the double arrow 258. Since the teachings of the present invention can be used in a relatively hostile environment, the magnetic code plate 230 is less susceptible to the build-up of films which might attenuate optical signals or corrode reflective surfaces which would be utilized with an optical code plate. However, the optical code plate is a one step transducer from position to optical signature and is inherently EMI immune. The magnetic code plate 230 is similar to the code plate shown in FIG. 10 since it shows the use of four distinct tracks 236, 238, 240 and 242. Each of the tracks is provided with its own magnetic field modulated optical absorption cells 244, 246, 248 and 250. Similar to the sensor heads shown in FIG. 1, these cells should be provided at a relatively close distance from the code plate 230. The use of the four tracks 236, 238, 240 and 242 would result in the utilization of a plurality of four digit words. A single optical fiber 234 would run transverse to the tracks and through each of the cells 244, 246, 248 and 250. The single optical fiber 234 is aligned to the degree that a position along track 236 differs from the position along track 242 by much less than the adjacent number center spacing. It is noted that the cells 244, 246, 248 and 250 are aligned with the center of each respective track and are embedded in the space between connected fiber links of optical fiber or waveguide 234.

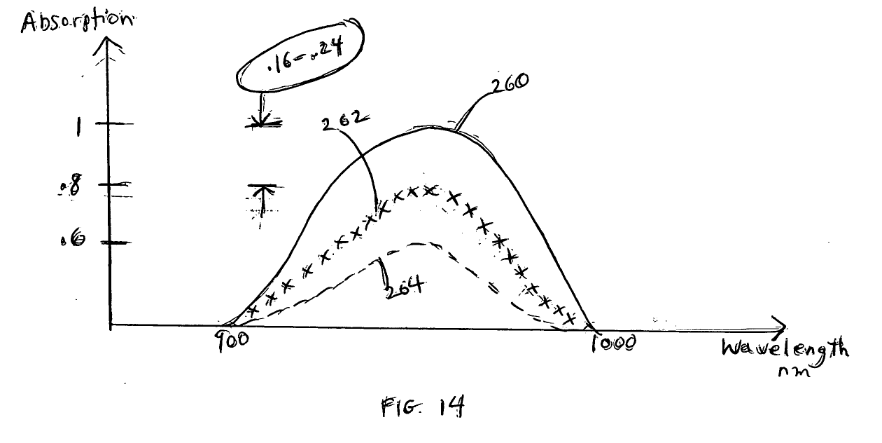

It is noted that each of the cells 244, 246, 248 and 250 act as a passive optical sensor using a semiconducting carbon nanotube material similar to the material described in U.S. patent application publication 2005/0248768 to Pettit. This patent application publication describes various optical properties of the carbon nanotube material. One of these properties would change the amplitude or absorption of a particular wavelength of light due to the presence of a magnetic field. Based upon the fact that this absorption is responsive to variable levels of the magnetic field, different magnetic field strengths can represent the different signal levels illustrated in FIG. 10. Although not shown, permanent magnets of different strengths would be embedded into each of these tracks corresponding to different signal levels. For example, as shown in FIG. 14, the amplitude of a particular waveform represents the three outputs of three permanent magnets of different strengths representing signals 0, 1 and 2, shown in FIG. 10. Optical transmission spectrum 260 could represent signal 2, optical transmission spectrum 262 could represent signal 1 and optical transmission spectrum 264 could represent signal 0. It is important that the magnetic field strengths of the permanent magnets representing the signal levels 0, 1, and 2 be such that the exact signal level can be recognized by each cell 244, 246, 248 and 250. The various magnetic strengths of each of these magnetic fields should be at least 10 Gauss different from one another. For example, the permanent magnet used to represent signal level 0 could be 10 Gauss, the magnetic field of the permanent magnet representing signal level 1 could be 20 Gauss and the magnetic field of the permanent magnet representing signal 2 can be 30 Gauss. However, as can be appreciated, although FIGS. 10, 11 and 14 show three distinct signal levels, more signal levels can be utilized.

Each of the optical absorption cells 244, 246, 248 and 250 are sensitive to different wavelengths of light than the other optical absorption cells. Consequently, a source of light, such as multiplexed lasers 232, would be utilized to produce a plurality of different wavelengths of light. The number of different wavelengths would be dependent upon the number of optical absorption cells and tracks employed. Therefore, the full spectrum of these particular wavelengths would be transmitted through the optical fiber 234 and through each of the optical absorption cells 244, 246, 248 and 250. The absorption and amplitude of each of the spectra would be modified based upon the magnetic field of the particular permanent magnet aligned with that particular optical cell at any one time. The signals produced by each of the optical absorption cells would be transmitted over the fiber optic cable or waveguide 234 to a demultiplexing unit 252. This demultiplexed signal would then be processed by a signal processor 244 in communication with a computer 256. The computer would include software therein which would read the particular digital word produced by the optical absorption cell array. Once this particular digital word has been sensed, the exact position of the code plate 230 is determined, defining the exact position of the actuator associated with the code plate.

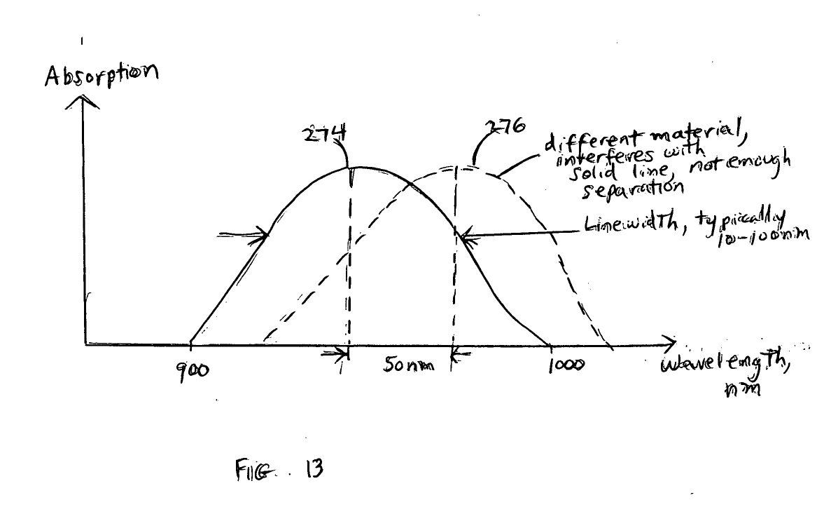

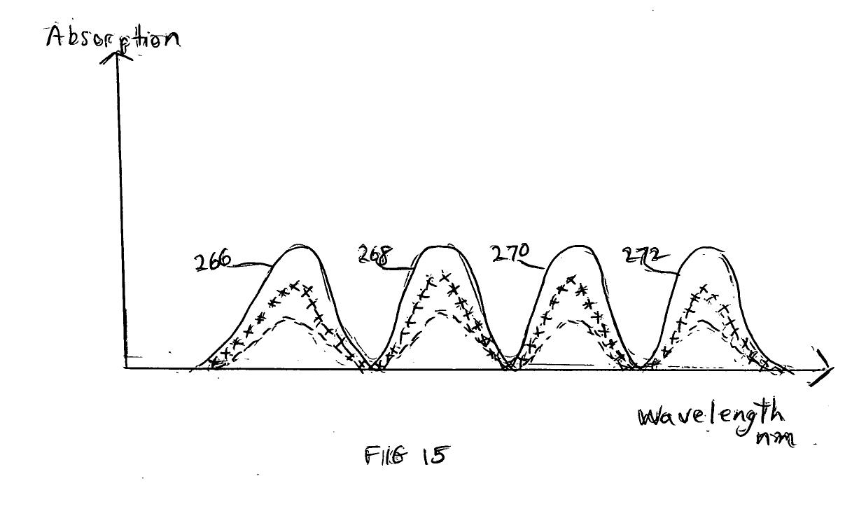

FIG. 15 shows the potential output 266, 268, 270 and 272 of the optical absorption cells 244, 246, 248 and 250 using the waveform levels shown in FIG. 14. As can be appreciated, the wavelength of each of the light waves must be sufficiently offset from any of the wavelengths of the other light sources to avoid cross-talk and interference. This problem is illustrated in FIG. 13, in which interference or cross-talk is created by the close separation of light waveforms 274 and 276. A separation of at least 100 nm between wavelengths is suggested.

Due to the importance of the separation of the light spectra used in conjunction with the magnetic code plate illustrated in FIG. 11, if additional tracks are required or warranted, it would be difficult to utilize a single fiber optic or waveguide. Hence, in this situation, an additional loop including a laser source and a plurality of optical absorption cells would be employed.

FIG. 12 describes use of an optical code plate 280. In this example, as was true with respect to the use of the magnetic code plate 230, four optical code plate tracks 282, 284, 286 and 288 are used to produce a plurality of four digit words. Additionally, similar to the magnetic code plate 230, a position on every one of the tracks would represent one of three different signal levels. Furthermore, as was true with respect to the sensor heads used with the magnetic code plate, the distance of the optical sensors, such as optical waveguide reflection read heads 290, 292, 294 and 296 associated with tracks 282, 284, 286 and 288, respectively, should be as close to the surface of each track as possible. The optical waveguide reflection read heads 290, 292, 294 and 296 are aligned to the degree that a position along track 282 would differ from the position along track 288 by much less than the adjacent number center spacing.

Each of the tracks are coated with patterned reflective material, such as gold, having discrete reflection values producing three levels of optical signals suitable for position coding as previously described. A multiplexed laser source would be utilized with a plurality of wavelength division multiplexing (WDM) splitters to direct light having four different wavelengths to the four different read heads associated with each of the tracks. These splitters would include dichroic mirrors 328, 330 and 336. The multiplexed lasers are connected to a fiber optic or waveguide 300, which would include sections 302, 304, 310 and 314 to direct the specific distinct wavelengths to the respective read heads 290, 292, 294 and 296. Each of these read heads would be similar to the read head illustrated with respect to FIG. 9. The incoming wavelengths would be directed to a specific point on the code plate and would be modulated based upon the reflectivity of the pattern reflective material associated with one of the three signal levels. The reflected signals from each of the read heads would be combined using dichroic mirrors 332, 334 and 340. Thus, signals would be transmitted over optical fiber or waveguide sections 306, 312, 316, 318 and 320 and are combined into a single wavelength division multiplexed signal along waveguide or fiber 308. This signal is transmitted to a demultiplexer 322 and signal processor 324 and then to a computer 326 which would utilize the information garnered through the use of the code plate 280 to determine the exact position of the code plate and its associated actuator. Similar to the combination shown in FIG. 11, the code plate 280 would move in the direction shown by the double sided arrow 328. Furthermore, similar to the magnetic code plate system, it is possible that the array of sensors or read heads 290, 292, 294 and 296 would move as a unit and the code plate would be stationary.

Cross-talk or interference can be reduced by coating each of the tracks 282, 284, 286 and 288 with a narrow transmission band dichroic filter that restricts transmitted light to the appropriate wavelength associated with that track. Measurement resolution is defined by the size of the read head waveguides along the measurement direction.

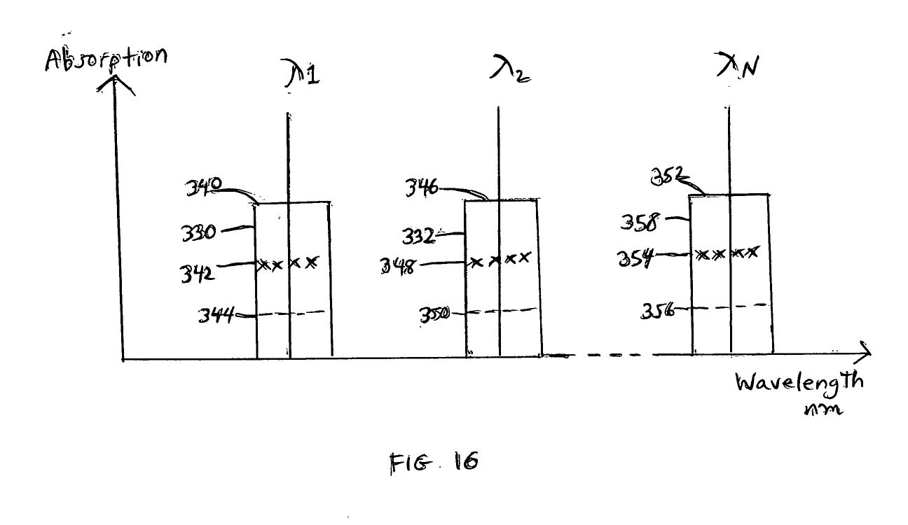

FIG. 16 illustrates a possible output of N tracks of the optical code plate shown in FIG. 12. The amplitude of each of these signals would be a function of the particular reflective coating at any point on a track indicative of a particular signal level. For example, optical transmission spectrum 330 would have an amplitude level 344 for a signal level 0 in FIG. 10, a height of 342 for signal level 1 and a height of 340 for signal level 2. Similarly, optical transmission spectrum 332 would have an amplitude level 350 for a 0 signal, an amplitude level 348 for the 1 signal and an amplitude level 346 for the 2 signal. Finally, optical transmission spectrum 338 would have an amplitude level 356 for signal 0, an amplitude level 354 for signal 1 and an amplitude level 352 for signal 2.

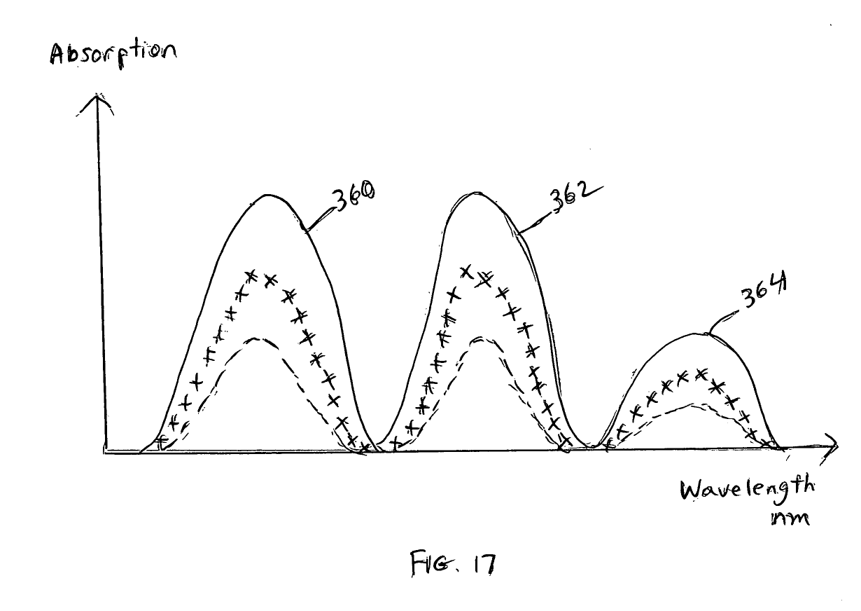

FIG. 17 describes a situation in which signal degradation has occurred for a signal related to one of the tracks in either the magnetic code plate or the optical code plate. This could occur, for example, due to a loss of power output from any of the read heads associated with the optical code plate or the magnetic code plate. It is noted that waveforms 360 and 362 appear to be normal, whereas waveform 364 appears to be abnormal. The values associated with each of the M possible discrete levels are compressed in tandem. This condition can be accommodated by a calibration change in a signal processing software contained in a computer used to run the system.

The above described embodiments are merely illustrative of the principals of the present invention. Other embodiments of the present invention will be apparent to those skilled in the art without departing from the spirit and scope of the present invention. For example, although the second embodiment was described using a WDM technique, time division multiplexing (TDM) could also be employed.

What is claimed is:

1. An encoder used to determine the position of a moving element, comprising:
a code plate moving in concert with the moving element, said code plate provided with N parallel tracks, each position along each of said N parallel tracks having one of M discrete signal levels associated therewith, wherein M≧2;
a plurality of stationary sensor heads facing said code plate used to determine the particular signal level provided at a particular point on each of said N parallel tracks, one of said sensor heads provided for each of said N parallel tracks;
an optical emitter producing an optical beam including a spectrum of light provided with at least N distinct wavelengths, said optical emitter connected to said plurality of stationery sensor heads, each of said wavelengths modulated by one of said M signal levels; and
a signal processor connected to each of said plurality of sensor heads for determining the position of said code plate with respect to said plurality of sensor heads based upon said N wavelengths of said optical beam being modulated by one of said M signal levels at a particular point on said code plate;
whereby the position of said code plate is related to the position of the moving element.

2. The encoder in accordance with claim 1, wherein said code plate is provided with a plurality of N bit digital words, and further wherein one of said N bit digital words is produced by the modulation of said N wavelengths of said optical beam, said N bit digital word compared to one of a plurality of N bit digital words stored in a computer connected to said signal processor, said N bit digital word indicative of the position of said code plate and the moving element.

3. The encoder in accordance with claim 2, wherein a plurality of N digital words are arranged in said code plate in a Gray code configuration.

4. The encoder in accordance with claim 1, wherein each of said stationary sensor heads is provided at the same longitudinal position of said code plate as the remainder of said stationary heads.

5. The encoder in accordance with claim 1, wherein said sensor heads are constructed of a semiconducting carbon nanotube material.

6. The encoder in accordance with claim 5, wherein each position of said code plate is embedded with a permanent magnet, the magnetic field strength of each of said permanent magnets exhibiting one of M signal strengths, the field strength of said permanent magnet modulating one of said N distinct wavelengths.

7. The encoder in accordance with claim 6, including a single optic fiber connected between, said optical emitter, said plurality of sensor heads and said signal processor.

8. The encoder in accordance with claim 1, wherein the reflectivity of each position of said code plate is one of M signal values, said reflectivity modulating one of said N distinct wavelengths.

9. An encoder used to determine the position of a moving element, comprising:
a stationary code plate, said code plate provided with N parallel tracks, each position along each of said N parallel tracks having one of M discrete signal levels associated therewith, wherein M≧2;
a plurality of movable sensor heads facing said code plate, said plurality of said sensor heads moving in concert with the moving element to determine the particular signal level provided at a particular point on each of said N parallel tracks, one of said sensor heads provided for each of said N parallel tracks;
an optical emitter producing an optical beam including a spectrum of light provided with at least N distinct wavelengths, said optical emitter connected to said plurality of sensor heads, each of said wavelengths modulated by one of said M signal levels; and
a signal processor connected to each plurality of moveable sensor heads for determining the position of said sensor heads with respect to said code plate based upon said N wavelengths of said optical heads being modulated by one of said M signal levels at a particular point on said code plate;
whereby the position of said plurality of sensors is related to the position of the moving element.

10. The encoder in accordance with claim 9, wherein said code plate is provided with a plurality of N bit digital words, and further wherein one of said N bit digital words is produced by the modulation of said N wavelengths of said optical beam, said N bit digital word compared to one of a plurality of N bit digital words stored in a computer connected to said signal processor, said N bit digital word indicative of the position of said plurality of sensor heads and the moving element.

11. The encoder in accordance with claim 10, wherein a plurality of N digital words are arranged in said code plate in a Gray code configuration.

12. The encoder in accordance with claim 9, wherein each of said movable sensor heads are provided at the same longitudinal position of said code plate as the remainder of said movable sensor heads.

13. The encoder in accordance with claim 9, wherein said sensor heads are constructed of a semiconducting carbon nanotube material.

14. The encoder in accordance with claim 13, wherein each position of said code plate is embedded with a permanent magnet, the magnetic field strength of each of said permanent magnets exhibiting one of M signal strengths, the field strength of said permanent magnet modulating one of said N distinct wavelengths.

15. The encoder in accordance with claim 14, including a single optic fiber connected between, said optical emitter, said plurality of sensor heads and said signal processor.

16. The encoder in accordance with claim 9, wherein the reflectivity of said position of said code plate is one of M signal values, said reflectivity modulating one of said N distinct wavelengths.

17. The encoder in accordance with claim 1, wherein M=3 and N=4.

18. The encoder in accordance with claim 9, wherein M=3 and N=4.

19. The encoder in accordance with claim 2, further including a signal processing algorithm in said computer for determining the position of said code plate to a fraction of a bit spacing of said N bit digital word provided on said code plate when one of said sensor heads is positioned at a transition point between two of said M discrete signal levels.

20. The encoder in accordance with claim 10, further including a signal processing algorithm in said computer for determining the position of said sensors to a fraction of a bit spacing of said N bit digital word provided on said code plate, when one of said sensor heads is positioned at a transition point between two of said M discrete signal levels.
